(19) United States
(12) Patent Application Publication
(10) Pub. No.: US 2020/0039067 A1
(43) Pub. Date: Feb. 6, 2020

(54) ROBOT CAPABLE OF AUTONOMOUS DRIVING THROUGH IMITATION LEARNING OF OBJECT TO BE IMITATED AND AUTONOMOUS DRIVING METHOD FOR THE SAME

(71) Applicant: LG ELECTRONICS INC., Seoul (KR)

(72) Inventor: Jae Yoon JEONG, Seoul (KR)

(73) Assignee: LG ELECTRONICS INC., Seoul (KR)

(21) Appl. No.: 16/598,879

(22) Filed: Oct. 10, 2019

(30) Foreign Application Priority Data
Aug. 28, 2019 (KR) PCT/KR2019/010995

(51) Int. Cl. B25J 9/16; G06N 20/00; G05B 13/02

(52) U.S. Cl. CPC B25J 9/163; G05B 13/028; G06N 20/00

(57) ABSTRACT

An artificial intelligence (AI) robot capable of performing imitation learning of an imitation target to be imitated may collect olfactory information of the imitation target and motion information about a motion executed by the imitation target according to the olfactory information for imitation learning, and may perform machine learning. When learned olfactory information is detected by the AI robot, the AI robot may be caused to execute the motion information about the motion executed by the imitation target. Accordingly, an imitation robot may imitate the imitation target based on olfactory information, in addition to sound and image information.

### CROSS-REFERENCE TO RELATED APPLICATION

This present application claims benefit of priority to International Patent Application No. PCT/KR2019-010995, entitled “Robot capable of autonomous driving through imitation learning of object to be imitated and autonomous driving method for the same,” filed on Aug. 28, 2019, in the Korean Intellectual Property Office, the entire disclosure of which is incorporated herein by reference.

### BACKGROUND

### 1. Technical Field

The present disclosure relates to an autonomous driving robot for performing imitation learning of an imitation target to be imitated, and an autonomous driving method of a robot that performs imitation learning. More particularly, the present disclosure relates to a technology in which a robot learns olfactory information of the imitation target and motion information of the imitation target relating to the olfactory information in order to imitate an action of the imitation target, and executes a motion of the imitation target when the learned olfactory information is detected.

### 2. Description of Related Art

The content described below serves simply to provide background information about embodiments of the present disclosure, and does not necessarily constitute related art.

Recently, various types of robots are being widely used in industrial sites or homes to perform given tasks. In particular, animal-shaped robots are widely used to detect landmines in war, to assist with household chores in a home, and as a toy.

In particular, a robot formed in the shape of a pet may perform activities for assisting the elderly, in addition to assisting with household chores at home and playing a role as a toy. In order to allow such a robot to perform activities for assisting the elderly, the robot may be configured to use a system that, when information such as an action and sound made by a pet is inputted in advance when the pet comes into contact with the elderly person, discharges information such as an action and sound made by a pet.

For example, such a robot substituting for a pet may generate sound (for example, a dog's sound). Here, the robot may be configured to have a structure in which, when a specific person performs a specific action in a state in which a person who uses the robot has inputted a sound of the robot, the robot expresses a dog's sound in the same manner as a general dog.

However, existing technology for a robot substituting for a pet is configured to mainly learn motion information and sound information, and a technology of performing learning using olfactory information is not disclosed.

Specifically, Korean Patent Application Publication No. 10-2002-0043982, entitled “An intelligent robotic bird based on speaking and learning” (hereinafter referred to as “Related Art 1”) discloses a pet robot for imitating person's words, performing learning based thereon, and recognizing and outputting words or sentences that a user pronounces.

However, Related Art 1 merely discloses a technology in which a storage medium in which person's words are imitated is outputted through a pet robot, and fails to specifically disclose a technology of imitating an animal's sounds using olfactory information collected through a living animal, or of imitating a person's voice by collecting human olfactory information.

In addition, Korean Patent Application Publication No. 10-2012-0106772, entitled “Robot” (hereinafter referred to as “Related Art 2”), proposes a dog-shaped robot using an olfactory sensor. Related Art 2 proposes a technology in which a dog-shaped robot uses an olfactory sensor to acquire information associated with chemical substances.

In Related Art 2, chemical substances that cannot be recognized as odors by an animal such as a human may be detected, and a location where chemical substances are generated, may be determined.

Therefore, Related Art 2 includes a feature of detecting harmful substances that are difficult for humans to measure in addition to chemical substances that cannot be recognized as odors by animals such as humans, but does not disclose a technology of learning smells of humans and animals, and imitating an action or sound of a pet based on the learned smells.

Thus, there is a need for a technique for more precisely imitating actions and sounds of pets living with humans.

Korean Patent Application Publication No. 10-2002-0043982 (2002.06.12)

Korean Patent Application Publication No. 10-2012-0106772 (2012.09.26)

### SUMMARY OF THE INVENTION

An aspect of the present disclosure is to precisely imitate an imitation target to be imitated, by allowing olfactory information accessed by the imitation target to be used as imitation information of the imitation target in order to imitate an action and a sound of the imitation target, and by using olfactory information in addition to information such as motion and sound information to imitate the imitation target.

Another aspect of the present disclosure is to provide an artificial intelligence (AI) robot capable of performing machine learning to learn olfactory information in addition to information such as motion and sound information to imitate an imitation target to be imitated.

Another aspect of the present disclosure is to provide a robot capable of performing autonomous driving that learns olfactory information in addition to information such as motion and sound information to imitate the imitation target, and executes a motion or sound of the imitation target when the learned olfactory information is detected based on learned learning information.

A method for imitating a motion of an imitation target to be imitated according to an embodiment of the present disclosure may include collecting olfactory information accessed by the imitation target and motion information of the imitation target from an olfactory sensor mounted adjacent to a face portion of the imitation target and an acceleration sensor mounted in a part of a body of the imitation target, the motion information being generated by the acceleration sensor according to the olfactory information, learning a relationship between the collected olfactory information and a motion of the imitation target, and storing the learned relationship as a program in a memory.

Specifically, in the method, when the motion information of the imitation target is collected, olfactory information of a product preferred by the imitation target or olfactory information of body odor information of a moving object that is to be detected and that reacts to an action of the imitation target may be acquired. Here, whether the product is a product preferred by the imitation target may be determined based on whether the imitation target comes into contact with the product after the product is recognized.

Here, when the olfactory information is acquired, when the olfactory sensor detects olfactory information of the product preferred by the imitation target or olfactory information of the body odor information of the object to be detected, unique information of the product preferred by the imitation target may be identified and stored.

Thus, when olfactory information to imitate the imitation target is used, only a product preferred by the imitation target may be selected.

In the method, when the relationship between the collected olfactory information and the motion of the imitation target is learned, a correlation between the motion information of the imitation target and olfactory information of a product preferred by the imitation target or olfactory information of body odor information of an object to be detected may be analyzed.

That is, when the olfactory information of the imitation target is collected, the motion information of the imitation target collected by the acceleration sensor may be collected at the same time, and a change in motion according to the olfactory information may be analyzed.

In the method, after the relationship between the olfactory information and the motion of the imitation target is learned, a process of collecting the motion information of the imitation target and learning the relationship between the olfactory information and the motion of the imitation target may be repeated at predetermined times or according to a predetermined period.

Specifically, when the olfactory information of the imitation target or the motion information relating to the olfactory information changes, the changed olfactory information and the changed motion information may be collected and learned in real time.

An apparatus for imitating a motion of an imitation target to be imitated according to another embodiment of the present disclosure may include an olfactory sensor disposed adjacent to a face portion of the imitation target, an acceleration sensor disposed in a joint of the imitation target, and a learning module configured to receive olfactory information and motion information collected by the olfactory sensor and the acceleration sensor, and learn a relationship between the collected olfactory information and the collected motion information.

Specifically, a motion of the imitation target may be learned using olfactory information in addition to motion information and sound information collected from the imitation target to be imitated, thereby more precisely imitating the imitation target.

The olfactory sensor of the apparatus may acquire olfactory information of a product preferred by the imitation target and body odor information of a moving object that is to be detected and that reacts to an action of the imitation target. Here, whether the product is a product preferred by the imitation target may be determined based on whether the imitation target comes into contact with the product after the product is recognized.

When the olfactory sensor detects olfactory information of the product preferred by the imitation target or olfactory information of the body odor information of the object to be detected, the learning module of the apparatus may identify and store unique information of the product preferred by the imitation target or unique information of the body odor information.

Thus, when olfactory information to imitate the imitation target is used, a product preferred by the imitation target or an object to be detected may be selected.

When the olfactory sensor detects olfactory information of the product preferred by the imitation target or olfactory information of the body odor information of the object to be detected, the learning module of the apparatus may learn a correlation between the olfactory information and motion information of the product preferred by the imitation target collected by the acceleration sensor.

That is, when the olfactory information of the imitation target is collected, the motion information of the imitation target collected by the acceleration sensor may be collected at the same time, and a change in a motion according to the olfactory information may be learned.

The olfactory sensor and the acceleration sensor of the apparatus may collect the olfactory information and the motion information according to a predetermined period within a predetermined time range.

As a result, the learning module may learn a relationship between the olfactory information and the motion information collected by the olfactory sensor and the acceleration sensor according to the predetermined period within the predetermined time range.

Specifically, when the olfactory information of the imitation target or the motion information relating to the olfactory information changes, the changed olfactory information and the changed motion information may be collected and learned in real time.

An autonomous driving method of a robot that imitates, through machine learning, a motion of an imitation target to be imitated according to another embodiment of the present disclosure may include acquiring olfactory information generated from an object to be detected, the object being located within a predetermined distance from a main body of the robot, identifying the olfactory information and determining whether olfactory information matching the identified olfactory information is in a program in which machine learning of a motion of the imitation target is performed, retrieving a motion of the imitation target corresponding to the olfactory information from the program when the olfactory information matching the identified olfactory information is in the program, and operating the robot such that the robot implements the retrieved motion of the imitation target.

Specifically, when a motion obtained by imitation learning of the imitation target is executed in the main body, olfactory information generated by an imitation target capable of being imitated may be detected in advance, and a motion or sound for motion information of the imitation target learned based on the detected olfactory information may be executed.

In the autonomous driving method, when the identified olfactory information is determined as olfactory information of a product preferred by the imitation target during determining whether the olfactory information matching the identified olfactory information is in the program, the robot may be operated with respect to the preferred product while tracking a location of the preferred product.

A robot capable of performing machine learning and autonomous driving to imitate a motion of an imitation target to be imitated through machine learning according to another embodiment of the present disclosure may include a main body capable of traveling, a sensor located within a predetermined distance from the main body and configured to acquire olfactory information generated from an imitation target capable of being imitated, and a controller configured to communicate with the main body and the sensor and execute a motion obtained by performing imitation learning of the imitation target in the main body.

Here, the controller may be configured to identify the olfactory information acquired by the sensor, determine whether olfactory information matching the identified olfactory information is in a program stored in a memory in which machine learning of a motion of the imitation target is performed, retrieve a motion of the imitation target corresponding to the olfactory information from the program when the olfactory information matching the identified olfactory information is in the program, and operate the robot such that the robot implements the retrieved motion of the imitation target.

That is, to imitate an imitation target, when olfactory information of a preferred product which is collected from the imitation target, or olfactory information of body odor information of an object to be detected is learned, and when the sensor of the robot detects the olfactory information collected by the imitation target, the robot may execute a motion and sound executed by the imitation target.

Thus, the robot may detect olfactory information in addition to information such as a motion and sound in order to imitate the imitation target, thereby expanding an imitation area of the imitation target.

When the identified olfactory information is determined as olfactory information of a product preferred by the imitation target, the controller of the robot may cause an operation of the robot which implements a motion of the imitation target to be performed with respect to the preferred product while tracking a location of the preferred product.

According to embodiments of the present disclosure, olfactory information acquired by an imitation target to be imitated may be learned through machine learning, and the learned olfactory information may be used as information to imitate the imitation target. That is, by using the olfactory information in addition to sound information and motion information generated by the imitation target to imitate the imitation target, information to imitate the imitation target may be diversified.

In addition, according to embodiments of the present disclosure, imitation may be performed based on olfactory information in addition to sound information and motion information generated by an imitation target in order to imitate the imitation target, and thus the imitation target may be more precisely imitated.

Furthermore, according to embodiments of the present disclosure, when olfactory information in addition to information such as a sound, a motion, and the like is learned to imitate an imitation target to be imitated through an AI robot capable of performing machine learning, and when the learned olfactory information is detected by the AI robot, the robot may imitate a motion or sound of the imitation target based on the olfactory information. Thus, when the robot capable of imitating the imitation target detects olfactory information in addition to information such as sound and motion, the imitation target may be imitated, thereby expanding an imitation area of the robot.

### BRIEF DESCRIPTION OF THE DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

FIG. 1 is a diagram schematically illustrating a relationship between a robot capable of performing machine learning and autonomous driving and an imitation target to be imitated by the robot according to an embodiment of the present disclosure.

FIG. 2 is a block diagram illustrating a robot capable of performing machine learning and autonomous driving, an imitation target to be imitated by the robot, and a learning module configured to learn information of the imitation target according to an embodiment of the present disclosure.

FIG. 3 is a block diagram illustrating a robot capable of performing machine learning and autonomous driving, a learning module configured to learn information of an imitation target, and an object to be detected according to an embodiment of the present disclosure.

FIG. 4 is a diagram schematically illustrating a process of learning information of an imitation target to be imitated and of imitating the imitation target by a robot capable of performing machine learning and autonomous driving according to an embodiment of the present disclosure.

FIG. 5 is a flowchart illustrating a process of learning information of an imitation target according to an embodiment of the present disclosure.

FIG. 6 is a flowchart illustrating a method by which a robot capable of performing machine learning and autonomous driving imitates an imitation target according to an embodiment of the present disclosure.

### DETAILED DESCRIPTION

Hereinafter, the present disclosure will be described in more detail with reference to the accompanying drawings. The present disclosure may be embodied in various different forms and is not limited to the embodiments set forth herein. Hereinafter in order to clearly describe the present disclosure, parts that are not directly related to the description are omitted. However, in implementing an apparatus or a system to which the spirit of the present disclosure is applied, it is not meant that such an omitted configuration is unnecessary. In addition, like reference numerals are used for like or similar components throughout the specification.

In the following description, although the terms “first”, “second”, and the like may be used herein to describe various elements, these elements should not be limited by these terms. These terms may be only used to distinguish one element from another element. Also, in the following description, the articles “a,” “an,” and “the,” include plural referents unless the context clearly dictates otherwise.

In the following description, it will be understood that terms such as “comprise,” “include,” “have,” and the like are intended to specify the presence of stated feature, integer, step, operation, component, part or combination thereof, but do not preclude the presence or addition of one or more other features, integers, steps, operations, components, parts or combinations thereof.

Hereinafter, a robot capable of performing machine learning and autonomous driving according to the present disclosure will be described in detail with reference to the accompanying drawings.

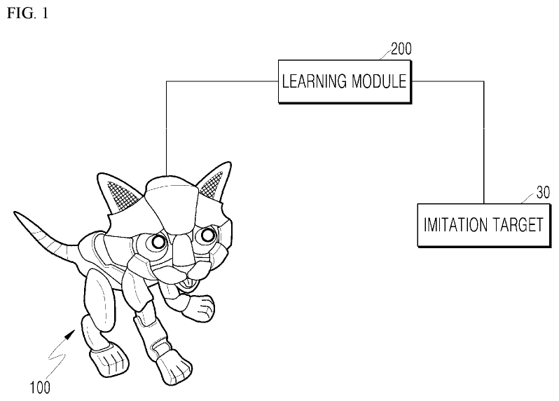

FIG. 1 is a diagram schematically illustrating a relationship between a robot capable of performing machine learning and autonomous driving and an imitation target to be imitated by the robot according to an embodiment of the present disclosure.

Although, by way of example, the robot described in the following embodiments is an autonomous mobile robot, it is to be noted that the robot may operate in any of an autonomous mode, a semi-autonomous mode, or a manual mode, without departing from the scope or spirit of the present disclosure. In addition, although, by way of example, a robot capable of performing machine learning and autonomous driving according to an embodiment of the present disclosure is a pet robot that imitates a pet, the robot may include, for example, a robot that is expressed in the form of an animal and that is capable of imitating an object in order to track a person or a product that is the subject of an accident at an accident scene, in addition to the pet robot.

Also, a robot 100 capable of performing machine learning and autonomous driving according to an embodiment of the present disclosure may be a joint robot including a speaker and a camera as a kind of an artificial intelligence (AI) robot, so as to imitate an action and sound of an imitation target 10 to be imitated.

In particular, the robot 100 capable of performing machine learning and autonomous driving may include an olfactory sensor to detect olfactory information stored in the imitation target 10. When information corresponding to prestored olfactory information is detected, the robot 100 may be configured to imitate an action and sound of the imitation target 10.

Here, although, by way of example, the imitation target 10 is a pet (for example, a cat or a dog), the imitation target 10 may be a lifesaving dog that rescues victims in an accident, a drug detection dog that detects drugs, and a military dog that acts in a military facility, in addition to a pet.

In order to imitate the imitation target 10, information extracted from the imitation target 10 needs to be learned. The robot 100 may imitate the imitation target 10 using a method of learning the information extracted from the imitation target 10 in a learning module 200 stored in a separate system, and transmitting the information learned in the learning module 200 to the robot 100 through communication between the robot 100 and the learning module 200.

Alternatively, when the learning module 200 is included in the robot 100 that imitates the imitation target 10, when information of the imitation target 10 is learned in the learning module 200 of the robot 100, and when olfactory information for imitation is detected by the robot 100, the robot 100 may be implemented to imitate the imitation target 10 based on the learned information.

In the following embodiment of the present disclosure, a description will be given of an example in which the robot 100 is implemented to imitate the imitation target 10 based on learned information when the learning module 200 is included in the robot 100 that imitates the imitation target 10, when information of the imitation target 10 is learned in the learning module 200 of the robot 100, and when olfactory information for imitation is detected by the robot 100.

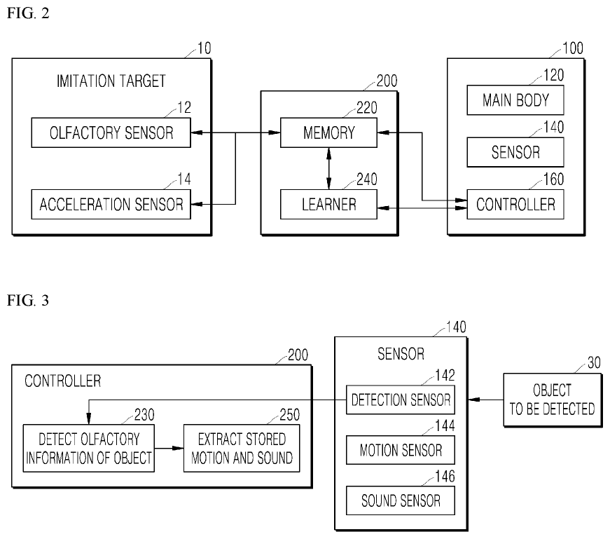

Hereinafter, an embodiment of learning of a learning module and a robot will be described with reference to FIGS. 2 and 3.

FIG. 2 is a block diagram illustrating a robot capable of performing machine learning and autonomous driving, an imitation target to be imitated by the robot, and a learning module configured to learn information of the imitation target according to an embodiment of the present disclosure, and FIG. 3 is a block diagram illustrating a robot capable of performing machine learning and autonomous driving, a learning module configured to learn information of an imitation target, and an object to be detected according to an embodiment of the present disclosure.

Referring to FIG. 2, before a robot 100 imitates an imitation target 10 to be imitated, a learning module 200 needs to learn information of the imitation target 10. To this end, the imitation target 10 may include an olfactory sensor 12 disposed adjacent to a face portion of the imitation target 10, and an acceleration sensor 14 disposed in a joint of the imitation target 10.

The learning module 200 that learns information of the imitation target 10 may receive olfactory information and motion information collected by the olfactory sensor 12 and the acceleration sensor 14 disposed in the imitation target 10, and may learn a relationship between the collected olfactory information and the collected motion information.

Specifically, the olfactory sensor 12 may be disposed around a nose of the imitation target 10 that recognizes olfactory information, and the acceleration sensor 14 may be disposed in each joint of the imitation target 10 to detect a motion of the imitation target 10. Then, when the imitation target 10 smells a specific object through the olfactory sensor 12 and when a response of a body to the specific object is collected by the acceleration sensor 14, the learning module 200 may learn response information associated with the specific object.

Here, the olfactory sensor 12 may collect olfactory information of a product preferred by the imitation target 10. The product preferred by the imitation target 10 may be, for example, a favorite object or a favorite food of the imitation target 10, and body odor information of an object to be detected (for example, a person) living with the imitation target 10.

Here, in order to determine whether a product is a product preferred by the imitation target 10, whether the imitation target 10 comes into contact with the product may be determined after the imitation target 10 recognizes the product.

That is, when the imitation target 10 smells a specific product and does not come into contact with the specific product again, the specific product may be determined not to be a product preferred by the imitation target 10. In order to determine that a product is preferred by the imitation target 10, a product that comes into contact with the imitation target 10 at least two times after the imitation target 10 smells the product may be assumed to be a product preferred by the imitation target 10.

The acceleration sensor 14 may detect information about an action of the imitation target 10 according to the olfactory information detected by the olfactory sensor 12. For example, when olfactory information about a product (for example, feed or a toy) usually preferred by a pet or an owner living with the pet is detected, an action toward the product or the owner may be caused to be executed. For example, when olfactory information about a product preferred by the imitation target 10, which is a pet, is detected, an action of barking, or an action of rotating at a current location may be performed. When the imitation target 10 detects body odor information of the owner, an action of coming into contact with a body of the owner may be performed. The above actions may be referred to as motions generated by the acceleration sensor 14 with respect to the product preferred by the imitation target 10.

Information of the imitation target 10 learned as described above may be learned in the learning module 200. Specifically, the learning module 200 may include a memory 220 and a learner 240.

The memory 200 may be configured to store unique information of a product preferred by the imitation target 10 which is collected by olfactory information of the imitation target 10, or unique information of body odor information of an object 30 to be detected. The object 30 to be detected may react to an action of the imitation target 10.

The memory 200 may also store motion information of the imitation target 10 relating to the collected olfactory information. That is, when a specific object and olfactory information about the specific object are detected, an action of the imitation target 10 may be stored.

When the learner 240 learns information stored in the memory 220, and when the robot 100 to be described below detects olfactory information of a product preferred by the imitation target 10 or olfactory information of body odor information of the object 30 to be detected, the learner 240 may enable an action corresponding to the detected olfactory information to be performed in the robot 100.

That is, when olfactory information that matches information stored in the learning module 200 is detected by the robot 100 to be described below, the information stored in the learning module 200 may be used as basic information to execute an action and sound made by the imitation target 10.

In this regard, when olfactory information of a product preferred by the imitation target 10 is detected by the olfactory sensor 12, the learning module 200 may learn a correlation between the olfactory information and motion information collected by the acceleration sensor 14 with respect to body odor information of the object 30 to be detected or the product preferred by the imitation target 10.

For example, when olfactory information about a product (for example, feed or a toy) usually preferred by a pet or an owner living with the pet is detected, an action toward the product or the owner may be caused to be executed. For example, when olfactory information about a product preferred by the imitation target 10, which is a pet, is detected, an action of barking, or an action of rotating at a current location may be performed. When the imitation target 10 detects body odor information of the owner, an action of coming into contact with a body of the owner may be performed. The above actions may be referred to as motions generated by the acceleration sensor 14 with respect to the product preferred by the imitation target 10, and the above relationship may be learned and stored in the learning module 200.

When the robot 100 to be described below detects olfactory information of a product preferred by the imitation target 10 or olfactory information of the object 30 to be detected, learning information stored as described above may be used to execute motion information stored according to a correlation.

When the learning module 200 stores and learns olfactory information and motion information of the imitation target 10, the robot 100 may operate based on the learned information.

To this end, the robot 100 may include a main body 120 capable of traveling, a sensor 140 that is located within a predetermined distance from the main body 120 and that is configured to acquire olfactory information generated by the imitation target 10, and a controller 160 that is configured to execute, using the main body 120, a motion obtained by imitation learning of the imitation target 10 based on the acquired olfactory information.

Specifically, the main body 120 may be formed in a shape similar to that of the imitation target 10. For example, the main body 120 may be formed in a shape similar to that of a pet, such as a cat or a dog. This is in order to allow the robot 100 to substitute for a pet when the motion executed by the robot 100 is seen by the object 30 to be detected.

The sensor 140 may include a detection sensor 142 capable of detecting olfactory information that matches the olfactory information collected by the imitation target 10, and a motion sensor 144 and a sound sensor 146 capable of collecting an action and sound of the imitation target 10.

The detection sensor 142 may be implemented as, for example, a sensor capable of detecting ingredients of a product preferred by the imitation target 10, and a sensor capable of analyzing and detecting ingredients of a body odor of the object 30 to be detected. More specifically, the detection sensor 142 may include a sensor array to which gas of the body odor of the object 30 to be detected or a product preferred by the imitation target 10 is inputted, and an extractor that extracts a characteristic from a signal inputted to the sensor array.

When specific olfactory information is collected by the detection sensor 142, a product and a body odor corresponding to the specific olfactory information collected by the detection sensor 142 may be detected by the detection sensor 142.

When olfactory information is detected through the sensor 140, the controller 160 may cause a sound or a motion performed by the imitation target 10 to be executed by the robot 100.

That is, in a state in which the olfactory information and the motion information of the imitation target 10 are stored in the learning module 200, the detection sensor 142 of the sensor 140 may identify the olfactory information of the imitation target 10 stored in the learning module 200, and may determine whether olfactory information matching the identified olfactory information is in a program stored in the memory 220 of the learning module 200. When the olfactory information matching the identified olfactory information is determined to be in the program, a motion or a sound of the imitation target 10 corresponding to the olfactory information stored in the memory 220 may be retrieved, and the robot 100 may be operated such that the robot 100 implements a motion of the imitation target 10.

Here, the olfactory information detected by the detection sensor 142 of the sensor 140 may be either olfactory information of a product preferred by the imitation target 10 or olfactory information of body odor information of an object to be detected (FIG. 3230).

When the identified olfactory information is determined to be olfactory information about a product preferred by the imitation target 10, the controller 160 may cause an operation of the robot 100 that implements a motion of the imitation target 10 to be performed with respect to the preferred product while tracking a location of the preferred product.

That is, the operation of the robot 100 may be performed with respect to only a favorite product of the imitation target 10, thereby enhancing precision of an imitation action that the robot 100 intends to imitate.

As described above, when olfactory information about the smell of the imitation target 10 and a motion of the imitation target 10 acting with respect to the olfactory information are learned and stored, and when the robot 100 that imitates the imitation target 10 detects the learned and stored olfactory information, the prestored motion of the imitation target 10 may be caused to be executed through the robot 100. Thus, imitating the imitation target 10 using an image and sound is not limited, and an action of the imitation target 10 acting with respect to smell when the smell is detected may be imitated (FIG. 3_250).

That is, the robot 100 may be enabled to detect olfactory information about, for example, the smell of a favorite product of the imitation target 10, or the smell of a target (for example, a missing person) that the imitation target 10 needs to smell. Thus, in the absence of the imitation target 10, the robot 100 may be enabled to perform an action of the imitation target 10 instead of the imitation target 10, thereby minimizing inconvenience experienced by the object 30 living with the imitation target 10 due to the absence of the imitation target 10. Furthermore, the robot 100 may be enabled to detect olfactory information of a target that the imitation target 10 needs to smell, and thus the robot 100 may perform an action instead of the imitation target 10 if necessary. Also, when it is difficult to access the imitation target 10 that is an actual animal even though the imitation target 10 urgently needs to be rescued, the robot 100 capable of detecting olfactory information of the imitation target 10 may be enabled to rescue the imitation target 10, thereby minimizing injury of the imitation target 10 while reducing a rescue time.

Referring back to the drawings, the olfactory sensor 12 and the acceleration sensor 14 of the imitation target 10 may collect the olfactory information and the motion information according to a predetermined period within a predetermined time range.

This is because, for example, a product preferred by the imitation target 10 or motion information of the imitation target 10 relating to a preferred product may change due to aging of the imitation target 10, or because olfactory information that the imitation target 10 needs to smell may change.

Thus, the olfactory sensor 12 and the acceleration sensor 14 may automatically collect olfactory information and motion information according to a predetermined period, or a user using the robot 100 may set the olfactory information and motion information to be collected according to an arbitrary period.

When the olfactory information and the motion information are collected according to a predetermined period within a predetermined time range as described above, the learning module 200 may learn a relationship between the olfactory information and the motion information based on the changed and collected olfactory information and motion information.

As described above, information learned in the learning module 200 may be automatically or manually updated, thereby enhancing a level of precision of imitation of the robot 100, and properly imitating an imitation target that needs to be imitated by the robot 100.

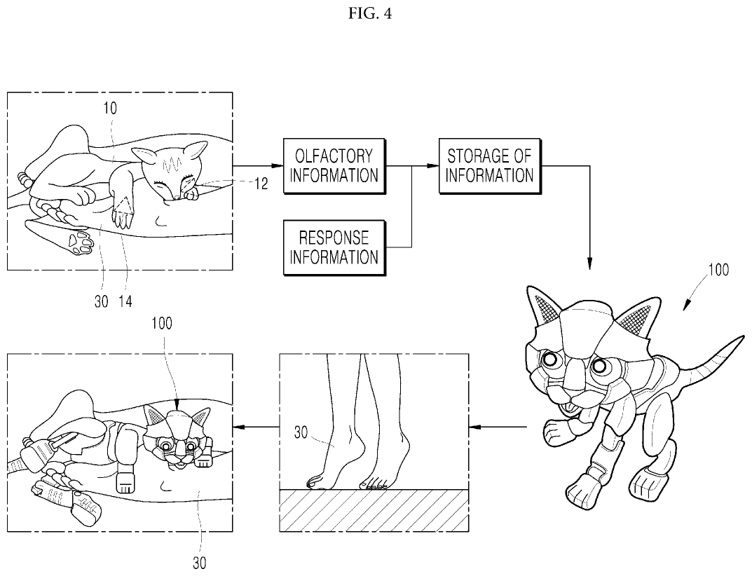

Hereinafter, a process of learning information of an imitation target to be imitated, and of imitating the imitation target by a robot capable of performing machine learning and autonomous driving according to an embodiment of the present disclosure is schematically described with reference to FIG. 4.

FIG. 4 is a diagram schematically illustrating a process of learning information of an imitation target to be imitated and of imitating the imitation target by a robot capable of performing machine learning and autonomous driving according to an embodiment of the present disclosure.

Prior to description of FIG. 4, for example, an imitation target 10 according to an embodiment of the present disclosure may be a cat, an object 30 to be detected may be a part of a body (for example, a foot) of a cat's owner, and a robot 100 may be a joint robot having the shape of a cat.

Referring to FIG. 4, the olfactory sensor 12 of the imitation target 10 may collect body odor information of the object 30 to be detected while the imitation target 10 is in contact with the object 30 to be detected. Here, the acceleration sensor 14 may collect motion information of the imitation target 10 while the olfactory sensor 12 is collecting olfactory information of the object 30 to be detected.

Olfactory information of the imitation target 10 collected as described above and response information that is motion information may be stored in the memory 220 of the learning module 200. The stored information may be information used to train the robot 100 such that a specific action of the robot 100 may be executed.

When the robot 100 to which information learned as described above is inputted detects body odor information of the object 30 to be detected, the robot 100 may execute motion information associated with an action of the imitation target 10 of coming into contact with a body of the object 30 to be detected.

According to the above-described embodiment of the present disclosure, the robot 100 capable of imitating an action may be enabled to imitate an action of the imitation target 10 when the robot 100 detects olfactory information collected from the imitation target 10, in addition to an image and sound, in order to imitate the imitation target 10.

Accordingly, for example, in the case of a drug detection dog for detecting drugs, drug detection is possible only at a specific location, but olfactory information (for example, smells of specific drug ingredients) that the drug detection dog needs to smell may be learned and stored, and a robot substituting for the drug detection dog may detect olfactory information that matches the learned and stored olfactory information, and may enable detection of drugs. After detecting drugs, the robot may perform an action (for example, barking) of the drug detection dog, to achieve maximum efficiency with minimal supply in order to select a specific target.

In an embodiment of the present disclosure, for example, when the robot 100 detects body odor information of a part of a body (for example, a foot) of the object 30 to be detected, an action of the imitation target 10 may be executed by the robot 100. Alternatively, the olfactory sensor 12 disposed in the imitation target 10 may collect body odor information generated according to a change in emotions of the object 30 to be detected, and the learning module 200 may learn the body odor information of the object 30 to be detected. Here, when olfactory information of the body odor information based on the change in emotions of the object 30 to be detected is detected, the robot 100 may be implemented to execute an action of the imitation target 10 according to circumstances.

Also, the olfactory sensor 12 and the acceleration sensor 14 of the imitation target 10 may collect olfactory information and motion information according to a predetermined period. This is because as the imitation target 10, which is an animal, ages, an amount of olfactory information collected may decrease, or a motion responding to the collected olfactory information may change.

By collecting the olfactory information and the motion information in the imitation target 10 according to a predetermined period as described above, the learning module 200 may learn a relationship between the olfactory information and the motion information based on the collected information.

Information learned in the learning module 200 as described above may be automatically or manually updated, thereby enhancing a level of precision of imitation of the robot 100, and properly imitating an imitation target that needs to be imitated by the robot 100.

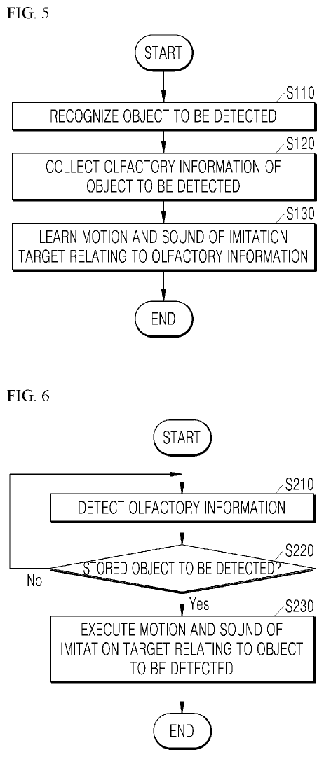

Hereinafter, a process of learning information of an imitation target and an imitation method of a robot are described with reference to FIGS. 5 and 6.

FIG. 5 is a flowchart illustrating a process of learning information of an imitation target according to an embodiment of the present disclosure, and FIG. 6 is a flowchart illustrating a method by which a robot capable of performing machine learning and autonomous driving imitates an imitation target according to an embodiment of the present disclosure.

In the description of the drawings to follow, where the reference numbers are the same as those of the apparatus and constituent elements described in FIGS. 1 to 4, it will be assumed that the reference numbers refer to the same apparatus and constituent elements as those described in FIGS. 1 to 4, and a detailed description thereof will thus be omitted.

Prior to description of FIGS. 5 and 6, although, by way of example, a robot according to an embodiment of the present disclosure is an AI robot capable of performing autonomous driving, it is to be noted that the AI robot may operate in an autonomous mode, a semi-autonomous mode, or a manual mode. In addition, although, by way of example, a robot capable of performing machine learning and autonomous driving according to an embodiment of the present disclosure is a pet robot that imitates a pet, the robot may include, for example, a robot that is expressed in the form of an animal and that is capable of imitating an object in order to track a person or a product that is the subject of an accident at an accident scene, in addition to the pet robot.

In addition, although, by way of example, the imitation target 10 according to an embodiment of the present disclosure is a pet (for example, a cat or a dog), the imitation target 10 may be a lifesaving dog that rescues victims in an accident, a drug detection dog that detects drugs, and a military dog that acts in a military facility, in addition to a pet.

As described above, according to an embodiment of the present disclosure, when specific olfactory information in the imitation target 10 and a motion of the imitation target 10 relating to olfactory information are learned, and when the robot 100 detects the specific olfactory information, the robot 100 may be enabled to execute a motion of the imitation target 10 based on learned information through communication with the robot 100.

Prior to imitating the imitation target 10, the robot 100 needs to learn information of the imitation target 10. To this end, the imitation target 10 needs to recognize the object 30 to be detected, or a product preferred by the imitation target 10, through the olfactory sensor 12 (S110).

That is, when the imitation target 10 smells a specific product and does not come into contact with the specific product again, the specific product may be determined not to be a product preferred by the imitation target 10. In order to determine that a product is preferred by the imitation target 10, a product that comes into contact with the imitation target 10 at least two times after the imitation target 10 smells the product may be assumed to be a product preferred by the imitation target 10. In the following embodiment of the present disclosure, a description will be given of an example in which an object recognized by the imitation target 10 is the object 30 to be detected.

When the imitation target 10 recognizes the object 30 to be detected, olfactory information of the object 30 to be detected may be collected (S120). Here, when the olfactory sensor 12 detects olfactory information of body odor information of the object 30 to be detected, motion information of the imitation target 10 with respect to the object 30 to be detected may be collected through the acceleration sensor 14 of the imitation target 10.

The collected olfactory information and the collected motion information may be unique information associated with body odor information of an object to be detected. The olfactory information and motion information stored as described above may be unique information about an action of the imitation target 10 relating to a body odor of the object 30 to be detected.

Next, stored information may be learned (S130). Specifically, when olfactory information of a product preferred by the imitation target 10 or olfactory information of body odor information of the object 30 to be detected is detected by the robot 100, information indicating that an action corresponding to the detected olfactory information may be executed by the robot 100 may be learned.

When olfactory information that matches information stored in the learning module 200 is detected through the robot 100, the learned information may be used as basic information to execute an action and sound made by the imitation target 10.

In this regard, when olfactory information of a product preferred by the imitation target 10 is detected in the olfactory sensor 12, a correlation between the olfactory information and motion information collected by the acceleration sensor 14 with respect to body odor information of the object 30 to be detected or the product preferred by the imitation target 10 may be learned.

For example, when olfactory information about a product (for example, feed, or a toy) usually preferred by a pet or an owner living with the pet is detected, an action on the product or the owner may be caused to be executed. For example, when olfactory information about a product preferred by the imitation target 10, which is a pet, is detected, an action of barking, or an action of rotating at a current location may be performed. When the imitation target 10 detects body odor information of the owner, an action of coming into contact with a body of the owner may be performed. The above actions may be referred to as motions generated by the acceleration sensor 14 with respect to the product preferred by the imitation target 10, and the above relationship may be learned and stored in the learning module 200.

When the robot 100 to be described below detects olfactory information of a product preferred by the imitation target 10 or olfactory information of the object 30 to be detected, the learning information stored as described above may be used to execute motion information stored according to a learned correlation.

That is, in a state in which the olfactory information and motion information of the imitation target 10 are stored in the learning module 200, the olfactory information of the imitation target 10 stored in the learning module 200 may be identified, and whether olfactory information matching the identified olfactory information is in a program stored in the memory 220 of the learning module 200 may be determined in the detection sensor 142 of the sensor 140. When the olfactory information matching the identified olfactory information is determined to be in the program, a motion or sound of the imitation target 10 corresponding to the olfactory information stored in the memory 220 may be retrieved, and the robot 100 may be operated to implement the motion of the imitation target 10.

A module that learns information of the imitation target 10 may collect and learn olfactory information and motion information of the imitation target 10 at predetermined times or according to a predetermined period.

This is because, for example, a product preferred by the imitation target 10 or motion information of the imitation target 10 with respect to a preferred product may change due to aging of the imitation target 10, or because olfactory information that the imitation target 10 needs to smell may be changed.

Thus, olfactory information and motion information may be automatically collected according to a predetermined period, or a user using the robot 100 may set the olfactory information and motion information to be collected according to an arbitrary period.

When olfactory information and motion information are collected according to a predetermined period within a predetermined time range as described above, a relationship between the olfactory information and the motion information may be learned based on olfactory information and motion information which are changed and collected.

Thus, by automatically or manually updating olfactory information detected by the robot 100 and motion information that needs to be executed, a level of precision of imitation of the robot 100 may be enhanced, and an imitation target that needs to be imitated by the robot 100 may be properly imitated.

When olfactory information of the imitation target 10 and motion information based on the olfactory information are learned, the robot 100 may operate based on the learned information.

Specifically, referred to FIG. 6, when olfactory information and motion information of the imitation target 10 are stored in the learning module 200, the sensor 140 of the robot 100 may detect the olfactory information of the imitation target 10 stored in the learning module 200 (S210).

When the olfactory information of the imitation target 10 stored in the learning module 200 is detected, whether the detected olfactory information matches the stored object 30 to be detected may be determined (S220). That is, whether the olfactory information detected by the sensor 140 of the robot 100 is either olfactory information of a product preferred by the imitation target 10 or olfactory information of body odor information of the object 30 to be detected may be determined.

When the olfactory information of the imitation target 10 stored in the learning module 200 is detected, and when the detected olfactory information is determined to match the stored object 30 to be detected, a prestored motion or sound of the imitation target 10 may be executed by the robot 100 (S230).

That is, in a state in which the olfactory information and the motion information of the imitation target 10 are stored in the learning module 200, the olfactory information of the imitation target 10 stored in the learning module 200 may be identified. Whether olfactory information matching the identified olfactory information is in a program stored in the memory 220 of the learning module 200 may be determined.

When the olfactory information matching the identified olfactory information is determined to be in the program, a motion or sound of the imitation target 10 corresponding to the olfactory information stored in the memory 220 may be retrieved, and the robot 100 may be operated such that the robot 100 implements the motion of the imitation target 10.

In other words, when olfactory information about the smell of the imitation target 10 and a motion of the imitation target 10 acting with respect to the olfactory information are learned and stored, and when the robot 100 that imitates the imitation target 10 detects the learned and stored olfactory information, the prestored motion of the imitation target 10 may be caused to be executed through the robot 100. Thus, imitating the imitation target 10 using an image and sound is not limited, and an action of the imitation target 10 acting with respect to smell when the smell is detected may be imitated.

In this regard, for example, the robot 100 may be enabled to detect olfactory information about, for example, the smell of a favorite product of the imitation target 10, or the smell of a target (for example, a missing person) that the imitation target 10 needs to smell. Thus, in the absence of the imitation target 10, the robot 100 may be enabled to perform an action of the imitation target 10, instead of the imitation target 10, thereby minimizing inconvenience experienced by the object 30 living with the imitation target 10 due to the absence of the imitation target 10.

Furthermore, the robot 100 may be enabled to detect olfactory information of a target that the imitation target 10 needs to smell, and thus the robot 100 may perform an action instead of the imitation target 10 if necessary. For example, when it is difficult to access the imitation target 10 that is an actual animal even though the imitation target 10 urgently needs to be rescued, the robot 100 capable of detecting olfactory information of the imitation target 10 may be enabled to rescue the imitation target 10, thereby minimizing injury of the imitation target 10 while reducing a rescue time.

As described above, olfactory information acquired by an imitation target to be imitated may be learned, and the learned olfactory information may be used as imitation information of an imitation robot that imitates the imitation target. That is, olfactory information in addition to sound information and motion information generated by the imitation target to imitate the imitation target may be used, thereby diversifying information for imitation of the imitation target.

In addition, imitation may be performed based on olfactory information in addition to sound information and motion information generated by the imitation target to imitate the imitation target, and thus the imitation target may be more precisely imitated.

In particular, information of a robot that imitates the imitation target may be periodically updated, and thus it is possible to increase accuracy of information used to imitate the imitation target and to enhance a level of precision of imitation of the robot.

Although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media such that the computer program is read and executed by a computer to implement embodiments of the present disclosure. Storage mediums such as a magnetic recording medium, an optical recording medium, and a semiconductor recording device may be employed as the storage medium of a computer program. Further, the computer program for implementing the embodiments of the disclosure includes a program module which is transmitted through an external device.

In the foregoing, while specific embodiments of the present disclosure have been described for illustrative purposes, the scope or spirit of the present disclosure is not limited thereto, it will be understood by those skilled in the art that various changes and modifications can be made to other specific embodiments without departing from the spirit and scope of the present disclosure. Therefore, the scope of the present disclosure should be defined not by the above-described embodiments but by the technical idea defined in the following claims.

Although the present disclosure has been described with reference to the embodiments, various changes or modifications can be made by those skilled in the art. Accordingly, it is to be understood that such changes and modifications are within the scope of the invention.

1. A method for imitating a motion of an imitation target to be imitated, the method comprising:
collecting olfactory information accessed by the imitation target and motion information of the imitation target from an olfactory sensor mounted adjacent to a face portion of the imitation target and an acceleration sensor mounted in a part of a body of the imitation target, the motion information being generated by the acceleration sensor according to the olfactory information;
learning a relationship between the collected olfactory information and a motion of the imitation target based on the collected olfactory information and the collected motion information; and
storing the learned relationship as a program in a memory.

2. The method according to claim 1, wherein
the collecting the olfactory information and the motion information comprises acquiring olfactory information of a product preferred by the imitation target or olfactory information of body odor information of a moving object to be detected, the moving object reacting to an action of the imitation target, and
whether the product is a product preferred by the imitation target is determined based on whether the imitation target comes into contact with the product after the product is recognized.

3. The method according to claim 2, wherein
the acquiring the olfactory information comprises, when the olfactory sensor detects the olfactory information of the product preferred by the imitation target or the olfactory information of the body odor information of the object to be detected, identifying and storing unique information of the product preferred by the imitation target or unique information of the body odor information of the object to be detected.

4. The method according to claim 1, wherein
the learning the relationship between the collected olfactory information and the motion of the imitation target comprises analyzing, by the olfactory sensor, a correlation between the motion information of the imitation target and olfactory information of a product preferred by the imitation target or olfactory information of body odor information of an object to be detected.

5. The method according to claim 1, further comprising, after the learning the relationship:
repeatedly performing the collecting the olfactory information and the motion information and the learning the relationship between the collected olfactory information and the motion of the imitation target at predetermined times or according to a predetermined period.

6. An apparatus for imitating a motion of an imitation target to be imitated, the apparatus comprising:
an olfactory sensor disposed adjacent to a face portion of the imitation target;
an acceleration sensor disposed in a joint of the imitation target;
a learning module configured to receive olfactory information and motion information collected by the olfactory sensor and the acceleration sensor, and to learn a relationship between the collected olfactory information and the collected motion information; and
a memory configured to store the learned relationship between the olfactory information and the motion information as a program.

7. The apparatus according to claim 6, wherein
the olfactory sensor acquires olfactory information of a product preferred by the imitation target and body odor information of a moving object to be detected, the moving object reacting to an action of the imitation target, and
whether the product is a product preferred by the imitation target is determined based on whether the imitation target comes into contact with the product after the product is recognized.

8. The apparatus according to claim 7, wherein
when the olfactory sensor detects olfactory information of the product preferred by the imitation target or olfactory information of the body odor information of the object to be detected, the learning module identifies and stores unique information of the product preferred by the imitation target or unique information of the body odor information.

9. The apparatus according to claim 7, wherein
when the olfactory sensor detects olfactory information of the product preferred by the imitation target or olfactory information of the body odor information of the object to be detected, the learning module learns a correlation between the olfactory information and motion information collected by the acceleration sensor with respect to the product preferred by the imitation target or the body odor information of the object to be detected.

10. The apparatus according to claim 6, wherein
the olfactory sensor and the acceleration sensor collect the olfactory information and the motion information according to a predetermined period within a predetermined time range, and
the learning module learns a relationship between the olfactory information and the motion information collected by the olfactory sensor and the acceleration sensor according to the predetermined period within the predetermined time range.

11. An autonomous driving method of a robot that imitates, through machine learning, a motion of an imitation target to be imitated which is implemented by the method of claim 1, the autonomous driving method comprising:
acquiring olfactory information generated from an object to be detected, the object being located within a predetermined distance from a main body of the robot;
identifying the olfactory information and determining whether olfactory information matching the identified olfactory information is in the method of claim 1;
when the olfactory information matching the identified olfactory information is in the program, retrieving a motion of the imitation target corresponding to the olfactory information from the program; and
operating the robot such that the robot implements the retrieved motion of the imitation target.

12. The autonomous driving method according to claim 11, wherein
the operating the robot comprises, when the identified olfactory information is determined as olfactory information of a product preferred by the imitation target during the determining whether the olfactory information matching the identified olfactory information is in the program, operating the robot with respect to the preferred product while tracking a location of the preferred product.

13. A robot capable of performing machine learning and autonomous driving for imitating a motion of an imitation target to be imitated, to which the apparatus of claim 6 is applied, the robot comprising:
a main body capable of traveling;
a sensor configured to acquire olfactory information generated from an object to be detected, the sensor being located within a predetermined distance from the main body; and
a controller configured to communicate with the main body and the sensor, and to execute a motion obtained by performing imitation learning of the imitation target through the main body,
wherein the controller is configured to:
identify the olfactory information acquired by the sensor;
determine whether olfactory information matching the identified olfactory information is in the program stored in the memory of claim 6;
retrieve a motion of the imitation target corresponding to the olfactory information from the program when the olfactory information matching the identified olfactory information is in the program; and
operate the robot such that the robot implements the retrieved motion of the imitation target.

14. The robot according to claim 13, wherein
when the identified olfactory information is determined as olfactory information of a product preferred by the imitation target, the controller is further configured to cause an operation of the robot which implements a motion of the imitation target to be performed with respect to the preferred product while tracking a location of the preferred product.
